(19) United States
(12) Patent Application Publication
(10) Pub. No.: US 2024/0399632 A1
(43) Pub. Date: Dec. 5, 2024

(54) METHOD FOR CONTINUOUSLY FORMING PLASTIC CAPS

(71) Applicant: YUAN PENG PLASTIC CO., LTD., Taichung City (TW)

(72) Inventor: FU HAO LIN, Taichung City (TW)

(21) Appl. No.: 18/327,481

(22) Filed: Jun. 1, 2023

(51) Int. Cl. B29C 45/00; B29C 45/26

(52) U.S. Cl. CPC B29C 45/0003; B29C 45/26; B29L 2031/565

(57) ABSTRACT

A method for continuously forming plastic caps has the following steps of: forming a first plastic cap strip in a mold by a first injection molding process, wherein the first plastic cap strip has a plurality of plastic caps that are connected in sequence; pulling the first plastic cap strip outwardly after the mold is opened, wherein a last one of the plastic caps is in a clamping mod cavity of the mold when the mold is closed; forming a second plastic cap strip by a second injection molding process, wherein a first plastic cap at a forefront end of the second plastic cap strip is connected to the last plastic cap of the first plastic cap strip. In this way, the plastic caps are formed continuously to simplify the manufacturing steps and reduce the manufacturing time. The manufacturing cost is low and the efficiency is high.

### FIELD OF THE INVENTION

The present invention relates to plastic caps, and more particularly to a method for continuously forming plastic caps used in conjunction with a nail gun.

### BACKGROUND OF THE INVENTION

Plastic caps are used in conjunction with a nail gun. When in use, plastic caps are mounted on the nail gun, and nails are driven to pass through the plastic caps and then fastened to a waterproof paper (or soundproof fabric) and the wall, so that the nails are secured to the waterproof paper (or soundproof fabric) more firmly via the plastic caps.

As disclosed in U.S. Pat. No. 7,207,095 titled “PROCESS FOR FORMING ELONGATED FLEXIBLE STRIP OF NAILING CAPS”, after a plastic material is introduced into several molds, a plurality of plastic cap strips each composed of connected plastic caps are formed by injection molding. However, the plastic cap strips are not connected to one another. It is necessary to connect the plastic cap strips by means of, for example, a high frequency, which leads to high manufacturing cost and complicated manufacturing process. The manufacturing efficiency cannot be improved effectively.

### SUMMARY OF THE INVENTION

The primary object of the present invention is to provide a method for continuously forming plastic caps. A last one of plastic caps of a first plastic cap strip formed by a first injection molding process has a connecting portion. A plastic cap at the forefront of a second plastic cap strip formed by a second injection molding process is connected to the last plastic cap of the first plastic cap strip via the connecting portion when a mold is closed. In this way, the plastic caps can be formed continuously. The manufacturing cost is low and the efficiency is high.

In order to achieve the foregoing object, the present invention provides a method for continuously forming plastic caps, comprising the following steps of:
a. forming a first plastic cap strip in a mold by a first injection molding process, wherein the first plastic cap strip has a plurality of plastic caps and at least one connecting portion connected between every adjacent two of the plastic caps, the first plastic cap strip includes a first plastic cap at a forefront end thereof and a last plastic cap at a distal end thereof, and one end of the last plastic cap, away from the first plastic cap, has a first connecting portion extending downwardly, outwardly;
b. pulling the first plastic cap strip outwardly after the mold is opened, wherein the mold has a mold cavity for forming the plastic caps and a clamping mold cavity located at a front end of the mold cavity, and the last plastic cap is in the clamping mod cavity and is covered by the clamping mod cavity when the mold is closed;
c. forming a second plastic cap strip by a second injection molding process, wherein a first plastic cap at a forefront end of the second plastic cap strip extends outwardly to form a second connecting portion connected to the last plastic cap of the first plastic cap strip and an upper first connecting portion along an upper edge of the first connecting portion.

Preferably, the mold cavity and the clamping mold cavity are formed by closing a first mold and a second mold of the mold. The second mold has a groove extending downwardly, outwardly at one end of the mold cavity away from the clamping mold cavity. One end of the clamping mold cavity, facing the mold cavity, has a groove extending downwardly, outwardly.

### BRIEF DESCRIPTION OF THE DRAWINGS

FIG. 1 is a flowchart of the steps of a first embodiment of the present invention;

FIGS. 2-4 are schematic views showing the operation of the first embodiment of the present invention;

FIG. 5 is a schematic cross-sectional view of the first embodiment of the present invention;

FIG. 6 is a schematic planar view of the first embodiment of the present invention, wherein the plastic cap strip has one first connecting portion;

FIG. 7 is a schematic planar view of a second embodiment of the present invention, wherein the mold is not filled with a plastic material;

FIG. 8 is a schematic cross-sectional view of the second embodiment of the present invention; and

FIG. 9 is a schematic planar view of the second embodiment of the present invention, wherein the plastic cap strip has two first connecting portions.

### DETAILED DESCRIPTION OF THE PREFERRED EMBODIMENTS

Embodiments of the present invention will now be described, by way of example only, with reference to the accompanying drawings.

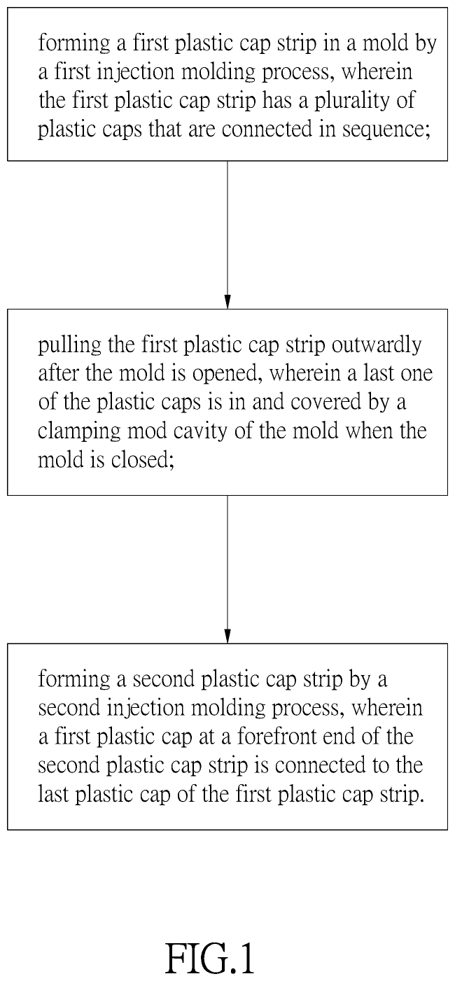

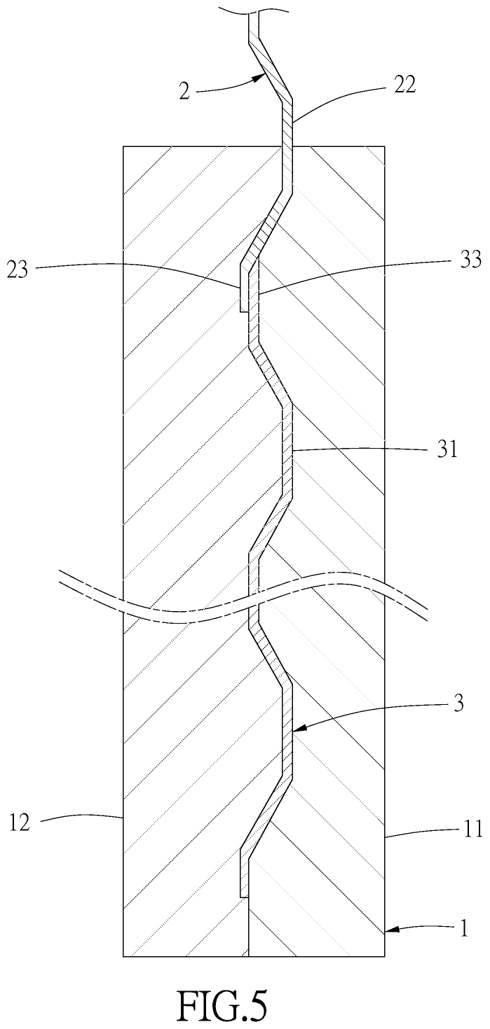

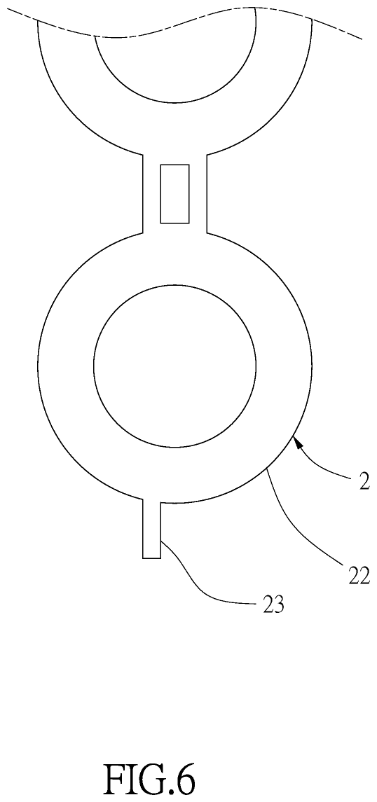

First of all, FIGS. 1 to 6 illustrate a first embodiment of a method for continuously forming plastic caps provided by the present invention. The plastic caps are formed using a mold 1 by injection molding.

The mold 1 consists of a first mold 11 and a second mold 12. When the first mold 11 and the second mold 12 are closed, the mold 1 has a mold cavity 13 for forming the plastic caps and a clamping mold cavity 14 located at a front end of the mold cavity 13. The second mold 12 has a groove 131 extending downwardly, outwardly at one end of the mold cavity 13 away from the clamping mold cavity 14. One end of the clamping mold cavity 14, facing the mold cavity 13, has a groove 141 extending downwardly, outwardly.

In actual implementation, the present invention comprises the following steps of:
a. forming a first plastic cap strip 2 in a mold 1 by a first injection molding process, wherein the first plastic cap strip 2 has a plurality of plastic caps and at least one connecting portion connected between every adjacent two of the plastic caps, the first plastic cap strip 2 includes a first plastic cap 21 at a forefront end thereof and a last plastic cap 22 at a distal end thereof, and one end of the last plastic cap 22, away from the first plastic cap 21, has a first connecting portion 23 extending downwardly, outwardly and corresponding in position to the groove 131;
b. pulling the first plastic cap strip 2 outwardly using a pulling mechanism (not shown in the figures) after the mold 1 is opened, wherein part of the last plastic cap 22 is covered by the clamping mod cavity 14 when the mold 1 is closed;
c. forming a second plastic cap strip 3 by a second injection molding process, wherein a first plastic cap 31 at a forefront end of the second plastic cap strip 3 extends outwardly to form a second connecting portion 32 connected to the last plastic cap 22 of the first plastic cap strip 2 and an upper first connecting portion 33 connected to the first connecting portion 23 along the upper edge of the first connecting portion 23.

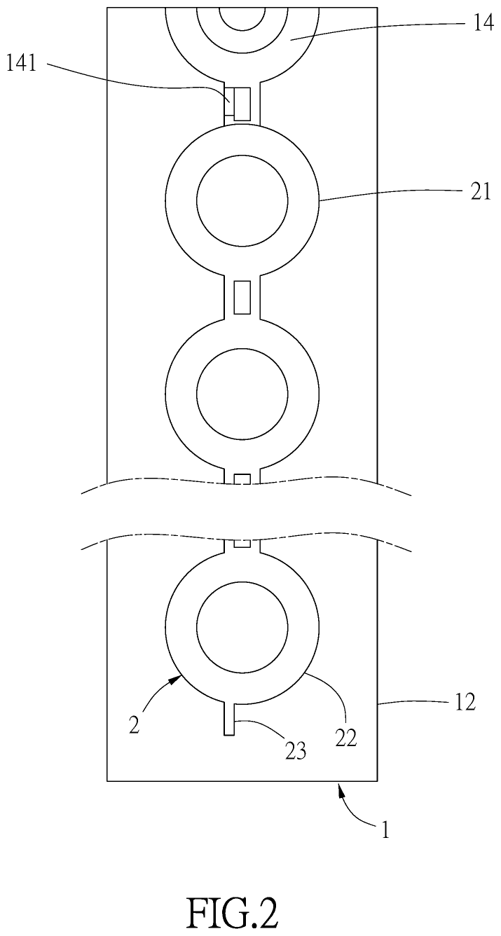

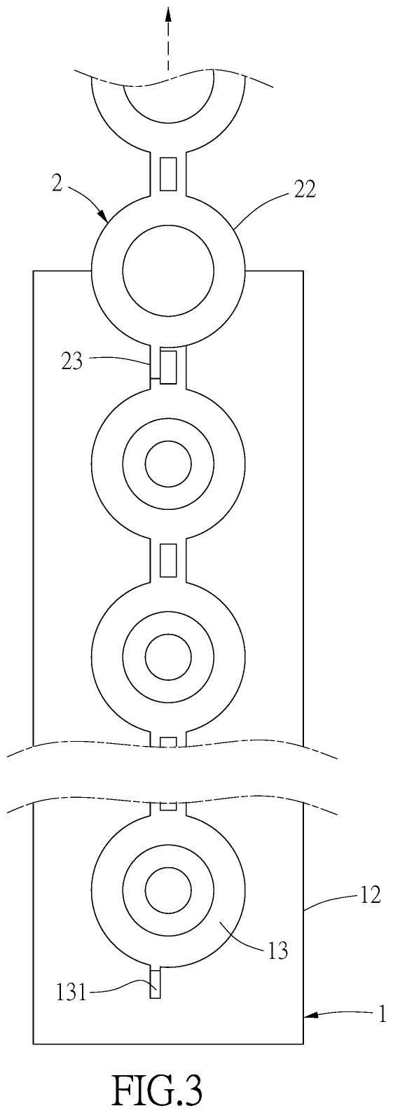

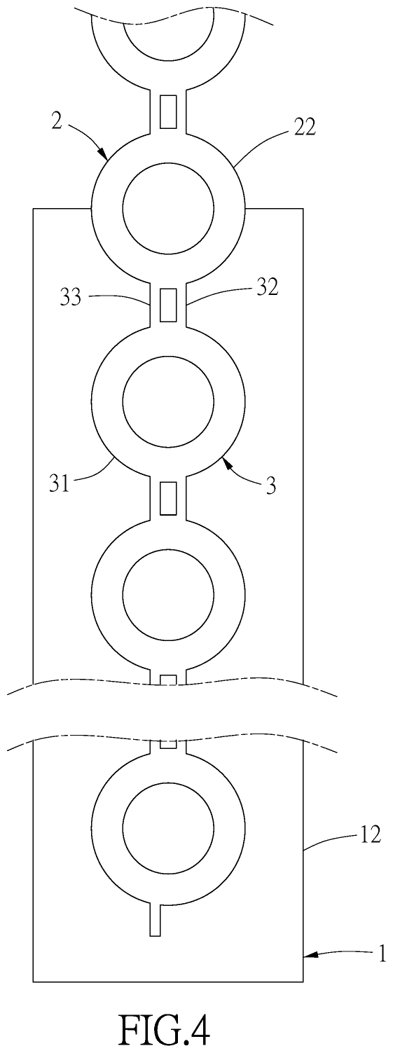

The present invention produces plastic caps by plastic injection molding for use in conjunction with a nail gun. As known from the above steps, referring to FIG. 2, firstly, a plastic material is introduced into the first mold and the second mold when the mold 1 is closed for forming the first plastic cap strip 2 in the mold cavity 13 by a first injection molding process. Next, as shown in FIG. 3, after the mold 1 is opened, the first plastic cap strip 2 is pulled outwardly using a pulling mechanism, and part of the last plastic cap 22 is covered by the clamping mod cavity 14 when the mold 1 is closed. Finally, as shown in FIG. 4, the second plastic cap strip 3 is formed by a second injection molding process. The second connecting portion 32 and the upper first connecting portion 33 of the first plastic cap 31 at the forefront end of the second plastic cap strip 3 are connected to the last plastic cap 22 of the first plastic cap strip 2. In this way, the second plastic cap strip 3 and the first plastic cap strip 2 are connected in the second injection molding process. Through the above steps, the effect of continuous injection molding can be achieved. The plastic cap strip can be connected to the next plastic cap strip by injection molding. There is no need for an additional means to connect the plastic cap strips, so as to simplify the manufacturing steps and reduce the manufacturing time. The manufacturing cost is low and the efficiency is high.

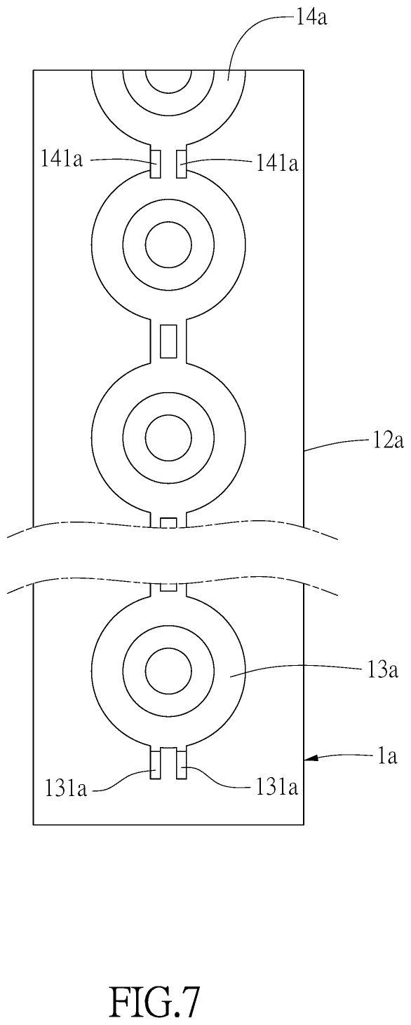

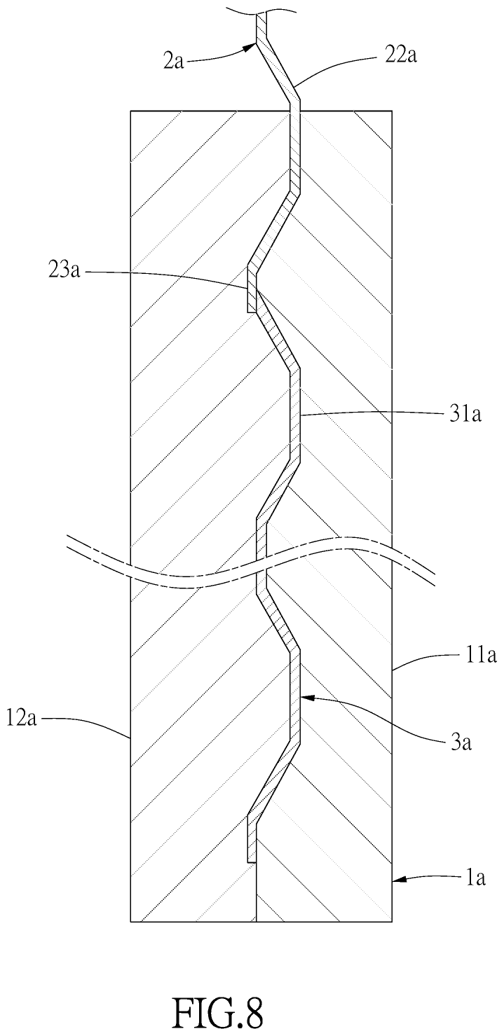

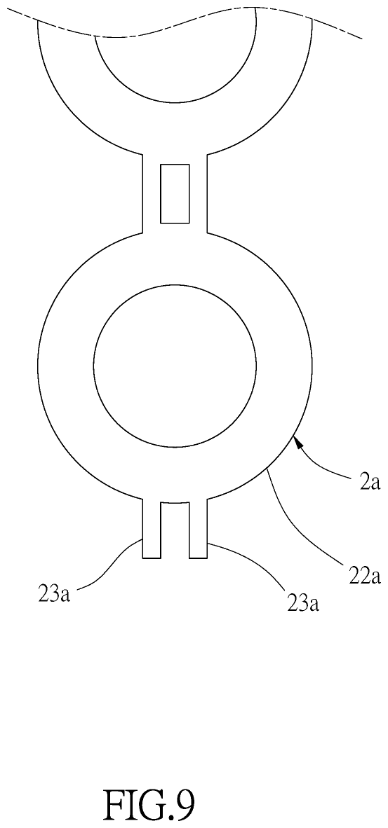

FIGS. 7 to 9 illustrate a second embodiment of a method for continuously forming plastic caps provided by the present invention. The second embodiment is substantially similar to the first embodiment with the exceptions described hereinafter. In the second embodiment, the second mold 12a of the mold 1a has two spaced grooves 131a extending downwardly, outwardly at one end of the mold cavity 13a away from the clamping mold cavity 14a, and one end of the clamping mold cavity 14a, facing the mold cavity 13a, has two spaced groove 141a extending downwardly, outwardly. One end of the last plastic cap 22a of the first plastic cap strip 2a, away from the first plastic cap, has two first connecting portions 23a extending downwardly, outwardly and corresponding in position to the grooves 131a.

The above structure is actually applied to the method for continuously forming plastic caps. Firstly, the first plastic cap strip 2a is formed in the mold. Next, after the mold 1a is opened, the first plastic cap strip 2a is pulled outwardly using a pulling mechanism, and the last plastic cap 22a is in the clamping mod cavity 14 and is covered by the clamping mod cavity 14 when the mold 1 is closed. The second plastic cap strip 3a is formed by a second injection molding process, and the bottom edge of the first plastic cap 31a at the forefront end of the second plastic cap strip 3a is connected to the top surfaces of the first connecting portions 23a of the first plastic cap strip 2a. Through the above steps, the effect of continuous injection molding can be achieved. The plastic cap strip can be connected to the next plastic cap strip by injection molding. There is no need for an additional means to connect the plastic cap strips, so as to simplify the manufacturing steps and reduce the manufacturing time. The manufacturing cost is low and the efficiency is high.

What is claimed is:

1. A method for continuously forming plastic caps, comprising the following steps of:
a. forming a first plastic cap strip in a mold by a first injection molding process, wherein the first plastic cap strip has a plurality of plastic caps and at least one connecting portion connected between every adjacent two of the plastic caps, the first plastic cap strip includes a first plastic cap at a forefront end thereof and a last plastic cap at a distal end thereof, and one end of the last plastic cap, away from the first plastic cap, has a first connecting portion extending downwardly, outwardly;
b. pulling the first plastic cap strip outwardly after the mold is opened, wherein the mold has a mold cavity for forming the plastic caps and a clamping mold cavity located at a front end of the mold cavity, and the last plastic cap is in the clamping mod cavity and is covered by the clamping mod cavity when the mold is closed;
c. forming a second plastic cap strip by a second injection molding process, wherein a first plastic cap at a forefront end of the second plastic cap strip extends outwardly to form a second connecting portion connected to the last plastic cap of the first plastic cap strip and an upper first connecting portion along an upper edge of the first connecting portion.

2. The method as claimed in claim 1, wherein the mold cavity and the clamping mold cavity are formed by closing a first mold and a second mold of the mold, the second mold has a groove extending downwardly, outwardly at one end of the mold cavity away from the clamping mold cavity, and one end of the clamping mold cavity, facing the mold cavity, has a groove extending downwardly, outwardly.

3. A method for continuously forming plastic caps, comprising the following steps of:
a. forming a first plastic cap strip in a mold by a first injection molding process, wherein the first plastic cap strip has a plurality of plastic caps and at least one connecting portion connected between every adjacent two of the plastic caps, the first plastic cap strip includes a first plastic cap at a forefront end thereof and a last plastic cap at a distal end thereof, and one end of the last plastic cap, away from the first plastic cap, has two spaced first connecting portions extending downwardly, outwardly;
b. pulling the first plastic cap strip outwardly after the mold is opened, wherein the mold has a mold cavity for forming the plastic caps and a clamping mold cavity located at a front end of the mold cavity, and the last plastic cap is in the clamping mod cavity and is covered by the clamping mod cavity when the mold is closed;
c. forming a second plastic cap strip by a second injection molding process, wherein a bottom edge of a first plastic cap at a forefront end of the second plastic cap strip is connected to top surfaces of the first connecting portions of the first plastic cap strip.

4. The method as claimed in claim 3, wherein the mold cavity and the clamping mold cavity are formed by closing a first mold and a second mold of the mold, the second mold has two spaced grooves extending downwardly, outwardly at one end of the mold cavity away from the clamping mold cavity, and one end of the clamping mold cavity, facing the mold cavity, has two spaced grooves extending downwardly, outwardly.
